(19) United States
(12) Patent Application Publication
(10) Pub. No.: US 2007/0125402 A1
(43) Pub. Date: Jun. 7, 2007

(54) Apparatus for cleaning seal bar in bag-making machine

(76) Inventors: Eric Marie De Smedt, Opwijk (BE); Emiel Yvonne Lambrecht, Gijzegem-Alast (BE)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/293,482

(22) Filed: Dec. 2, 2005

(51) Int. Cl. B08B 7/00

(52) U.S. Cl. 134/6; 53/167

(57) ABSTRACT

An apparatus for cleaning a seal bar of a bag-making machine comprises a frame positioned in operative association with the seal bar, and a carriage mounted on the frame for movement along the length thereof. An articulable cleaning member is mounted on the carriage for movement therewith along the frame, with the cleaning member including a cleaning head engageable with the seal bar by selective movement of the cleaning member relative to the carriage. By this arrangement, the cleaning head of the cleaning member can be positioned in engagement with the seal bar, and the carriage moved along the frame, whereby the cleaning head cleans/scraps the seal bar to remove built-up residue therefrom, thereby enhancing sealing performance.

### TECHNICAL FIELD

The present invention relates generally to a bag-making machine which forms bags or the like from heat-sealable material, such as a plastic web, and more particularly to an apparatus for use with such a machine which effects the cleaning/scraping of a seal bar of the bag-making machine which forms heat seals.

### BACKGROUND OF THE INVENTION

Various machines are known for effecting highly-automated manufacture of bags and like articles from heat-sealable material, such as webs of plastic film. During operation of such machines, the repetitive process of making heat seals, such as side weld seals, can cause certain deposits, present in or on the plastic film, to adhere and stick to, and build up on, the sealing edge of the sealing bar (sometimes referred to as the radius). Typically, deposits are non-flammable ink residues and different types of additives to the plastic film, such as white pigment additives.

Because the deposits, which can build-up on the seal bar, typically exhibit a low thermal conductivity, the build-up of deposits can undesirably reduce the heat flow from the seal bar to the web of film to be sealed. The build-up on the sealing edge of the seal bar also undesirably increases the radius of the sealing edge. This reduction in thermal conductivity and increase in the radius of the sealing edge can undesirably result in weakened sealing strengths, rougher seal appearance, which is less aesthetically pleasing, and increased standard deviations in seal strengths.

The present invention contemplates an apparatus for use with an associated bag-making machine for effecting automated cleaning of contaminated heat-seal seal bars.

### SUMMARY OF THE INVENTION

In accordance with the present invention, an apparatus for cleaning a seal bar of an associated bag-making machine includes a moveable carriage mounted in operative association with the seal bar to be cleaned/scraped. The apparatus includes a movable cleaning member, mounted on the carriage for movement therewith, with an arrangement of actuators provided for moving the cleaning member into cleaning engagement with the associated seal bar. After engagement with the seal bar, the apparatus is operated such that the carriage is moved along the length of the seal bar, thereby effecting removal of residue from the seal bar as the cleaning member moves with the carriage. The cleaning member can thereafter be disengaged and retracted from the seal bar, and operation of the bag-making machine continued.

In accordance with the illustrated embodiment, the seal bar cleaning apparatus of the present invention includes a frame positioned on the bag-making machine in operative association with the seal bar, with the frame extending in generally parallel relationship thereto.

The present apparatus further includes a carriage mounted on the frame for movement along the length thereof. In a current embodiment, a pneumatic actuator is provided for moving the carriage along the length of the associated frame.

In accordance with the present invention, the present apparatus includes a cleaning member mounted on the carriage for movement therewith along the associated frame. The cleaning member includes a cleaning head engageable with the associated seal bar by selective movement of the cleaning member relative to the carriage.

By this arrangement, the cleaning head of the cleaning member can be moved into engagement with the seal bar, and is thereafter moveable along the length of the seal bar by the movement of the carriage along the length of the frame. The cleaning head includes a suitable steel scraping tool or the like, whereby residue and other build-up on the seal bar is cleaned/scraped from the surface thereof. After cleaning in this fashion, the cleaning member is again moved relative to the carriage, such that the cleaning head is disengaged from the seal bar, and the associated bag-machine put back in operation.

In accordance with the illustrated embodiment, the apparatus includes a rigid support member mounted on the moveable carriage, and a pivotal support member pivotally joined to the rigid support member at a first pivot axis. The movable cleaning member, in turn, is joined to the distal end of the pivotal support member, preferably pivotally joined at a second pivot axis. By this arrangement, the cleaning member is moveable relative to both the first and second axes.

Selective movement of the cleaning member is effected by a first actuator for moving the pivot support member relative to the rigid support member about the first pivot axis. A second actuator is provided for moving the cleaning member relative to the pivotal support member about the second pivot axis. In this manner, the second actuator can be operated to position the cleaning head of the cleaning member along side of (i.e., beneath, in a current embodiment) the associated seal bar, with operation of the first actuator acting to move the cleaning head of the cleaning member into engagement with the seal bar. Subsequent translation of the carriage thus effects movement cleaning member along the length of the seal bar, with engagement of the cleaning head with the seal bar effecting the desired cleaning and scraping of the radiused seal bar surface

Other features and advantages of the present invention will become readily apparent from the following detailed description, the accompanying drawings, and the appended claims.

### BRIEF DESCRIPTION OF THE DRAWINGS

FIG. 1 is a diagrammatic view of the present seal bar cleaning apparatus shown in operative association with a bag-making machine; and

FIGS. 2 through 5 are perspective, diagrammatic views showing operation of the present seal bar cleaning apparatus.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

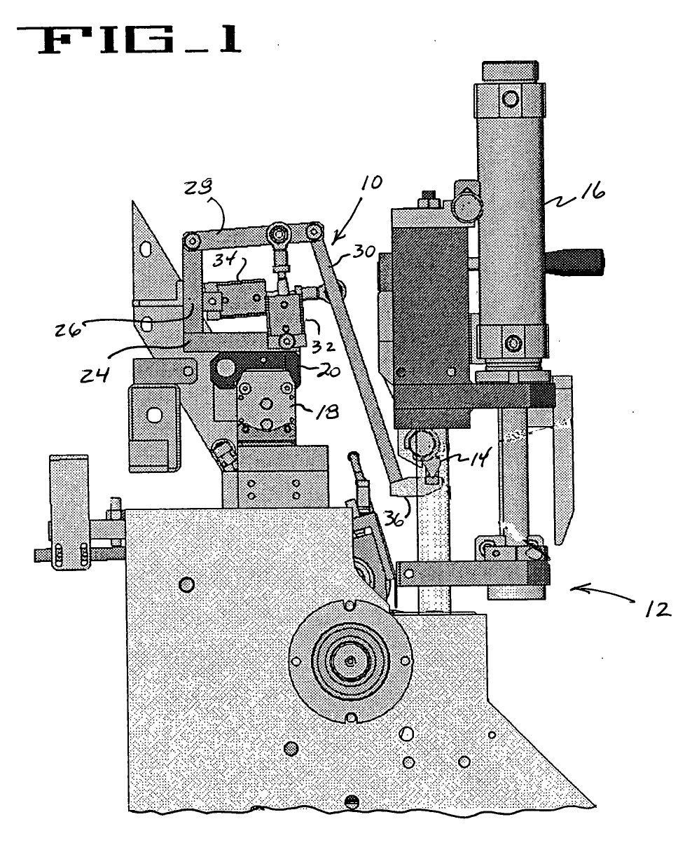

With reference now to the drawings, therein is illustrated a seal bar cleaning apparatus 10 embodying the principles of the present invention. The present seal bar cleaning apparatus is configured for use in association with a bag-making machine 12, exemplary features of which are illustrated in FIG. 1. In operation, this type of bag-making machine forms bags or like articles from a heat-sealable web of plastic film or the like, which web is folded, gusseted, and formed as may be required for forming the final bag. Typically, the bag-making machine includes mechanisms which are intermittently operated, whereby the various operations to be performed upon the plastic film web are effected. The present invention is described herein in association with a side weld seal bar application. However, the invention of the disclosure can be used for any method of sealing and/or cutting of thermoplastic film (the sealing can be done intermittently-continuously in the transverse direction and in the longitudinal direction of the web).

In a typical operation, a web of plastic film is unwound, typically from a power-driven unwind station, and is drawn over a folding board by the infeed section of the bag-making machine, thereby forming a J-folded web, wherein a lip is typically 35-45 millimeters wide. A bottom gusset may optionally be formed in the J-shaped web.

The present invention can be used in association with a variety of bag-making machines, with a typical example being a Model 5750W, available from Hudson-Sharp Machine Co., Green Bay, Wis. This bag-machine, sometimes referred to as a wicket machine, draws the J-folded web into the machine from an associated gusset former, by means of a set of nip rolls, typically driven by an AC motor. The AC motor is controlled by a frequency controller which receives a speed reference from the main machine controller, and a position feedback signal from an infeed dancer which is part of the infeed section, and located just downstream of the aforementioned nip rolls.

As a standard feature of a bag-making machine such as the aforementioned Model 5750W basic wicketing machine, the intermittent moving part of the machine consists of a servo-motor positioned single roll dancer, and a set of servo-driven nip rolls. In between these mechanisms, several attachments will typically apply certain transformations to the web of film, such as punching of wicket holes for stacking, and the photo eye for print registration.

The formation of the bags being formed is effected at the sealing section of a Model 5750W bag-making machine. Typically, the seals being formed are side seals, but it will be understood that an apparatus embodying the principles of the present invention can be employed for cleaning seal bars of a bag-making machine which form other types of seals. The sealing edge of the side weld seal bar is heated to a pre-set temperature and defines a certain radius. The temperature and radius of the sealing edge depend on the film thickness and film composition. The applied heat acts to separate the web from the drawn bag, and thereby form a seal between the different layers of film. Subsequently, the formed bags are picked-up and stacked for subsequent packaging, transport, and end use.

FIG. 1 illustrates a seal bar 14 of bag-making machine 12, wherein the seal bar 14 is mounted for reciprocal movement by operation of associated actuator 16. Seal bar 14 typically has a generally elongated configuration, and is sized for forming suitable heat-seals for the size of bags being formed by the machine 12.

As noted above, residue can build-up on the seal bar 14 attendant to operation of the bag-making machine 12. Because this build-up of residue can undesirably affect the performance of the sealing operation, the present cleaning apparatus 10 is configured for intermittent, periodic cleaning of the heated surface of the seal bar 14. To effect cleaning, operation of the bag-making machine 12 is interrupted, and the seal bar 14 is positioned in a relatively retracted position, as illustrated in FIG. 1.

The configuration and operation of the cleaning apparatus 10 will now be described.

Apparatus 10 includes a generally elongated frame 18 which is mounted on the associated bag-making machine 12, in operative association with the seal bar 14. The frame 18 extends in generally parallel relationship to the seal bar, whereby the length of the seal bar can be efficiently cleaned.

The cleaning apparatus 10 further includes a carriage 20 mounted on frame 18 for selective movement along the length thereof. A suitable pneumatic actuator can be provided for effecting longitudinal movement of the carriage 20, although it will be appreciated that other forms of linear drive arrangements, such as drive screws or the like, can be provided. End stops 22 act to control the range of motion of the carriage 20.

Carriage 20 includes a support plate 24 fixed thereto, which in turn carries an articulable linkage arrangement of the present cleaning apparatus. In particular, the cleaning apparatus 10 includes a rigid support member 26 mounted on support plate 24 and extending generally perpendicularly therefrom. A pivotal support member 28 is pivotally joined to the rigid support member 26 at a first pivot axis, which pivot axis extends generally parallel to the frame 18 of the apparatus along which carriage 20 moves.

The cleaning apparatus 10 further includes a generally elongated cleaning member 30 which is mounted on the carriage 20 for movement therewith, by virtue of the cleaning member 30 being pivotally joined to the distal end of pivotal support member 28 at a second pivot axis. The second pivot axis extends in parallel relationship to the first pivot axis, with the cleaning member 30 thus being movable relative to both the first and second axes.

Selective, articulating movement of the cleaning member 30 is effected by a pair of actuators, preferably pneumatic, which are configured to selectively move pivotal support member 28 relative to the first pivot axis at which it is joined to rigid support member 26, and cleaning member 30 relative to pivotal support member 28 about the second pivot axis at which the cleaning member is joined to the pivotal support member. To this end, a first actuator 32 (FIG. 1) extends between support plate 24 of carriage 20, and pivotal support member 28. A second actuator 34 extends between rigid support member 26 and cleaning member 30.

The cleaning member 30 includes a cleaning head 36, having a suitable cleaning element, such as formed from suitable steel or the like, which is engageable with the seal bar 14 of the bag-making machine 12. Cleaning of the seal bar is effected by engagement of the cleaning head 36 with the seal bar, followed by operation of carriage 20 so that it moves along the length of frame 18, with the cleaning head thereby cleaning and scraping the seal bar 14 as the carriage is translated along the length of the frame 18.

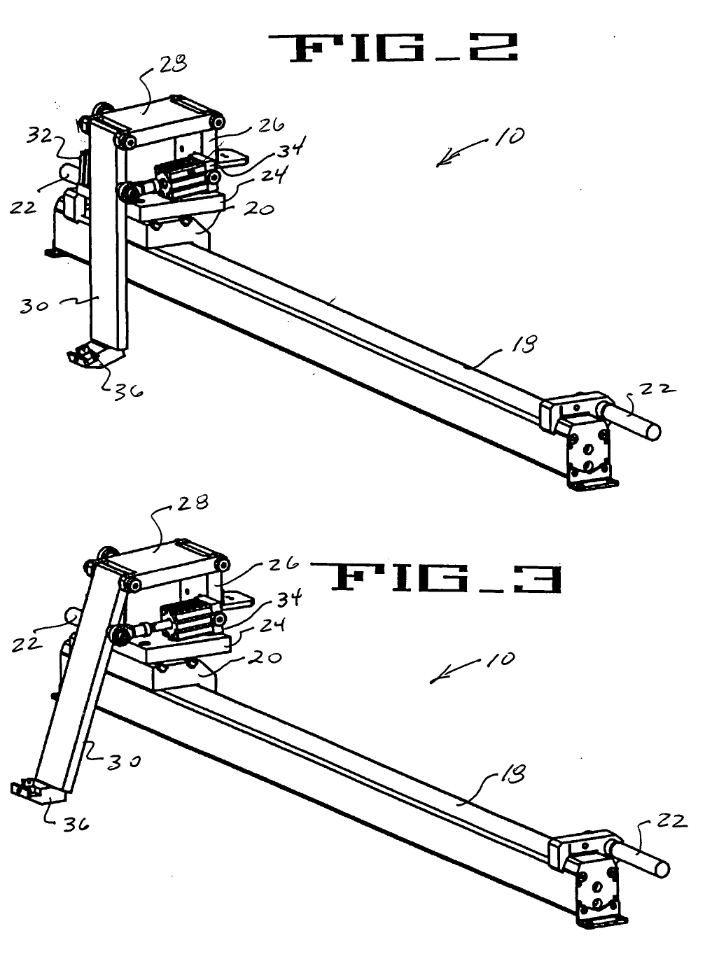

Operation of the cleaning apparatus 10 is illustrated in FIGS. 2-5.

Either automatically, or pursuant to an operator command, the seal bar 14 of bag-making apparatus 12 is positioned as illustrated in FIG. 1. With the seal bar 14 in this relatively retracted position, cleaning apparatus 10 is positioned as in FIG. 2, the so-called “home position”. Both of actuators 32 and 34 are in a retracted position.

With reference to FIG. 3, actuator 34 is operated such that cleaning member 36 is pivoted relative to pivotal support member 28 about the second pivot axis at which the members are pivotally joined. By operation in this fashion, the cleaning head 26 of the cleaning member is positioned generally adjacent to, but in spaced relationship to, the associated seal bar 14.

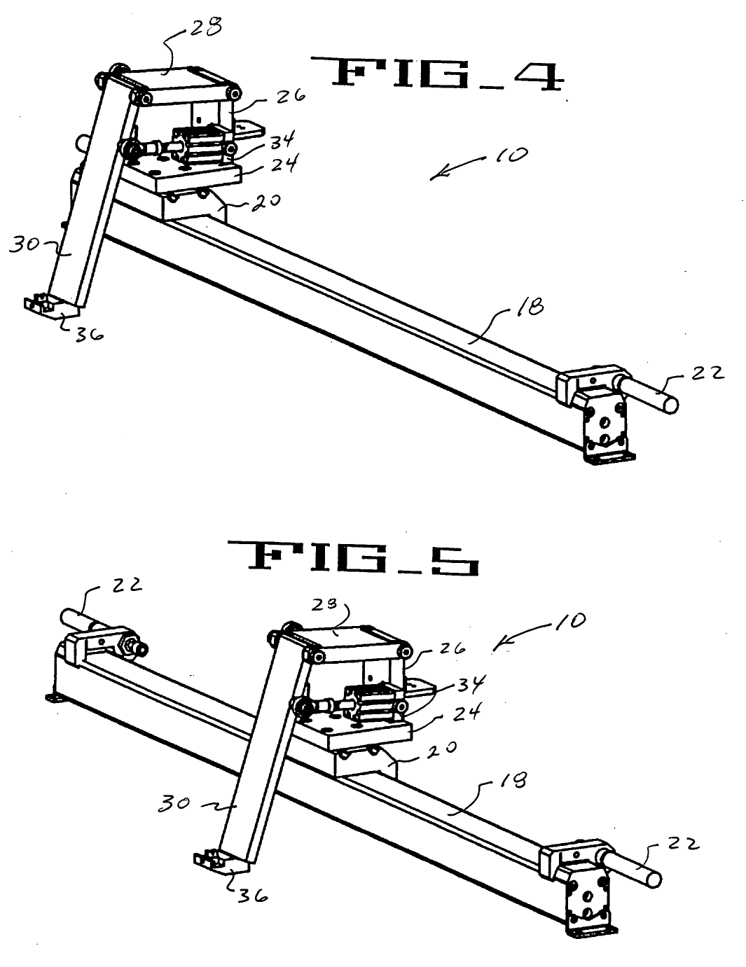

As illustrated in FIG. 4, the actuator 32 is next operated, thereby pivoting pivotal support member 28 relative to rigid support member 26 about the first pivot axis at which they are pivotally joined. By operation in this manner, the scraper of the cleaning head 36 is urged and biased into engagement with the radiused, heating surface of seal bar 14, generally in the relative orientation illustrate in FIG. 1. Actuators 32 and/or 34 can be operated to selectively vary the force of engagement of cleaning head 36 with seal bar 14, thus effectively removing varying types and/or levels of residue that may be present on the seal bar.

FIG. 5 illustrates translation of carriage 20 along frame 18, thereby acting to move cleaning head 36 along the length of the associated seal bar 14, effecting cleaning/scraping of residue and the like, built-up on the seal bar surface. While it is presently envisioned that cleaning will be effected as the carriage 20 of the cleaning apparatus moves in one direction along the associated frame 18, it will be appreciated that the apparatus can be operated to effect cleaning/scraping attendant to movement in either direction along the frame 18.

At the conclusion of the cleaning stroke, actuators 32 and 34 can be operated to disengage the cleaning head 36 from the seal bar, and relatively retract cleaning member 30. The carriage 20 can then be operated to return the apparatus to its “home” position.

As noted, the associated bag-making machine goes into a “virtual stop” for operation of the cleaning apparatus, whereby the ordinary “normal run sequence” of the bag-making machine is temporarily interrupted. The present seal bar cleaning apparatus can be operated in various fashions. For example, the machine operator can input a value related to a pre-determined number of bag intervals, or a pre-determined number of hour intervals, between each automatic cleaning cycle. The cleaning cycle can be automatic or manual, as may be desired.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. An apparatus for cleaning a seal bar of an associated bag-making machine, comprising;
a frame positioned in operative association with said seal bar, and extending in generally parallel relationship thereto;
a carriage mounted on said frame for movement along the length thereof; and
a cleaning member mounted on said carriage for movement therewith along said frame, said cleaning member including a cleaning head engageable with said seal bar by selective movement of said cleaning member relative to said carriage, said cleaning head being engageable with said seal bar and moveable along the length thereof by movement of said carriage along said frame.

2. An apparatus for cleaning a seal bar in accordance with claim 1, including
a rigid support member mounted on said carriage, and a pivotal support member pivotally joined to said rigid support member at a first pivot axis, said cleaning member being joined to said pivotal support member.

3. An apparatus for cleaning a seal bar in accordance with claim 2, wherein
said cleaning member is pivotally joined to said pivotal support member at a second pivot axis, whereby said cleaning member is moveable relative to said first and second pivot axes.

4. An apparatus for cleaning a seal bar in accordance with claim 3, including
a first actuator for moving said pivotal support member relative to said rigid support member about said first pivot axis, and a second actuator for moving said cleaning member relative to said pivotal support member about said second pivot axis.

5. An apparatus for cleaning a seal, bar in accordance with claim 4, wherein
said first actuator extends between said carriage and said pivotal support member, and said second actuator extends between said rigid support member and said cleaning member.

6. An apparatus for cleaning a seal bar in accordance with claim 1, including
an actuator for moving said carriage along the length of said frame.

7. A method of cleaning a seal bar, comprising the steps of:
providing a frame, and positioning said frame in operative association with said seal bar in generally parallel relationship thereto;
providing a carriage mounted on said frame for movement along the length thereof; and
providing a cleaning member mounted on said carriage for movement therewith along said frame, said cleaning member including a cleaning head engageable with said seal bar by selective movement of said cleaning member relative to said carriage;
engaging said cleaning head with seal seal bar; and
moving said carriage along said frame so that said cleaning head effects cleaning of said seal bar.

8. A method of cleaning in accordance with claim 7, wherein:
said engaging step includes pivoting said cleaning member relative to said carriage and thereafter moving said cleaning member so that said cleaning head engages said seal bar.

9. A method of cleaning in accordance with claim 8, wherein:
said steps for cleaning said seal bar are effected after operation of said bag-making machine for a pre-determined number of hours.

10. A method of cleaning in accordance with claim 8, wherein:
said steps for cleaning said seal bar are effected after operation of said bag-making machine for making a pre-determined number of bags.

11. A method of cleaning in accordance with claim 8, including:
selectively varying the force of engagement of said cleaning head with said seal bar.
